(19) United States
(12) Patent Application Publication
(10) Pub. No.: US 2026/0022025 A1
(43) Pub. Date: Jan. 22, 2026

(54) PROCESS FOR PRODUCING A HIGHLY CONCENTRATED PURE AQUEOUS SOLUTION OF MAGNESIUM HYDROGENCARBONATE OR CALCIUM HYDROGENCARBONATE AND PRESSURE VESSEL FOR STORING AND/OR DOSING THE SOLUTION INTO THE WATER TO BE OPTIMIZED

(71) Applicant: BWT Holding GmbH, Mondsee (AT)

(72) Inventors: Jürgen JOHANN, Mondsee (AT); Andrea PAVAN, Cittadella PD (IT); Christian SCHROTSHAMMER, Mondsee (AT); Claudia STOIBERER, Hallein (AT)

(73) Assignee: BWT Holding GmbH, Mondsee (AT)

(21) Appl. No.: 19/107,067

(22) PCT Filed: Sep. 5, 2023
(86) PCT No.: PCT/EP2023/074258

§ 371 Date: Feb. 27, 2025

(30) Foreign Application Priority Data
Sep. 8, 2022 (DE) 10 2022 122 779.0

(51) Int. Cl. C01F 5/24; B01J 41/10; C01F 11/18; C02F 1/68

(52) U.S. Cl. CPC C01F 5/24; B01J 41/10; C01F 11/18; C02F 1/687; C02F 2201/005; C02F 2209/05

(57) ABSTRACT

The disclosure relates to a process for producing magnesium hydrogen carbonate and/or calcium hydrogen carbonate. An anion exchanger loaded with bicarbonate ions is provided, and a solution containing magnesium salt and/or calcium salt is then passed through the anion exchanger.

### CROSS-REFERENCE TO RELATED APPLICATION

This application is a national stage application, filed under 35 U.S.C. § 371, of International Patent Application PCT/EP2023/074258, filed on Sep. 5, 2023, which claims the benefit of German Patent Application DE 10 2022 122 779.0, filed on Sep. 8, 2022.

### BACKGROUND

For many applications, the composition of water, especially water used for drinking or for preparing hot beverages such as coffee, is required to always be as consistent as possible in practice.

For example, in the industrial production of table water or water that is intended to subsequently be further processed into a hot or cold beverage such as coffee, beer or into soft drinks, it has been known to first demineralize the water. Thereafter, a defined amount of salt is added to the purified and nearly salt-free water in order to ensure a sufficient electrolyte concentration for human consumption.

Bicarbonates, e.g. NaHCO₃, KHCO₃, which are provided as solids and dissolve easily, are particularly suitable for the adding in a dosed manner.

Magnesium salts and calcium salts are nutritionally more valuable than sodium salts and potassium salts. It is therefore particularly desirable for the water to contain mainly magnesium and calcium as minerals.

In contrast to the alkali salts sodium hydrogen carbonate and potassium hydrogen carbonate, however, the hydrogen carbonates of the alkaline earth metals calcium and magnesium do not exist as solids. The hydrogen carbonates of calcium and magnesium are only available in dissolved form. Evaporation and concentration of the solution is not feasible, since this process will lead to the formation of calcium carbonate and/or magnesium carbonate, CO₂ and H₂O from the dissolved calcium hydrogen carbonate or magnesium hydrogen carbonate:

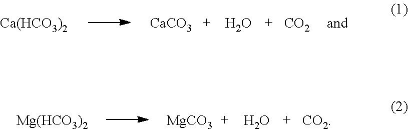

The carbonates of magnesium and calcium are poorly soluble and are the main cause of scale formation in installations and hot water heaters.

The hydrogen carbonates of the calcium metal or magnesium metal can be produced from two solutions. Usually, one solution consists of potassium hydrogen carbonate or sodium hydrogen carbonate, and the other solution consists of magnesium chloride or calcium chloride. If both solutions are mixed together, the desired calcium hydrogen carbonate or magnesium hydrogen carbonate will be obtained.

However, the solution obtained in this way is not pure, but also contains undesirable sodium chloride and/or potassium chloride.

As an example, the preparation of a 1% solution, or 10 g/l, of magnesium hydrogen carbonate shall be given.

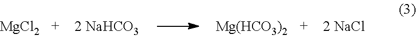

Here, approximately 8 g/l of NaCl are formed in addition.

Another option is the production of calcium hydrogen carbonate or magnesium hydrogen carbonate from magnesium carbonate or calcium carbonate and carbonic acid.

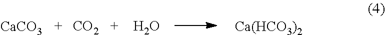

### Similarly for Mg:

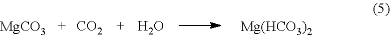

In both cases, pure hydrogen carbonate of calcium or magnesium, respectively, is formed, but the reaction of CO₂ with the respective carbonate is quite slow, since CO₂ or H₂CO₃ as the water-dissolved form, respectively, is only a weak acid (pKₐ₁=6.3 or pKₐ₂=10.3).

The respective carbonate dissolves only slowly and with a high stoichiometric excess of CO₂.

### SUMMARY

An object of the present disclosure is to produce a magnesium hydrogen carbonate solution or calcium hydrogen carbonate solution as pure as possible, which is stoichiometric and is obtained at a fast reaction rate.

The object is achieved by a process for producing magnesium hydrogen carbonate and calcium hydrogen carbonate, by treated water and by a pressure vessel as disclosed and claimed.

Preferred embodiments and further refinements of the invention will be apparent from the subject-matter of the dependent claims, the description and the drawings.

The disclosure relates to a process for producing magnesium hydrogen carbonate and/or calcium hydrogen carbonate. The process is in particular intended to produce a highly concentrated calcium hydrogen carbonate solution and/or magnesium hydrogen carbonate solution.

This solution preferably has a total hardness of more than 200° dH, particularly preferably of more than 400° dH, in particular between 400° dH and 800° dH.

An anion exchanger loaded with hydrogen carbonate ions, i.e. bicarbonate ions, is provided.

The ion exchanger may in particular come in the form of a weakly basic, medium basic or strongly basic anion exchanger. A mixture of weakly basic, medium basic and strongly basic ion exchanger material may also be used.

Basic ion exchangers may in particular contain amino groups as a functional group.

More particularly, the ion exchanger may be provided as a bulk material in a cartridge which has an inlet and an outlet for the concentrate to be enriched with magnesium hydrogen carbonate or calcium hydrogen carbonate.

Furthermore, according to the invention, a solution containing magnesium salt and/or calcium salt is passed through the anion exchanger loaded with hydrogen carbonate ions. Chlorides are preferably used as the magnesium salts or calcium salts. Magnesium sulfate can also be used as a magnesium salt.

For producing the desired magnesium hydrogen carbonate solution or calcium hydrogen carbonate solution, a solution of magnesium chloride and/or calcium chloride is passed through a weak and/or medium and/or strong anion exchanger, which is in the hydrogen carbonate form, whereby the chloride ion of the solution is exchanged for the bicarbonate ion of the anion exchanger.

The concentration of the feed solution of magnesium chloride and/or calcium chloride ranges from 0.05 mol/l to 0.3 mol/l.

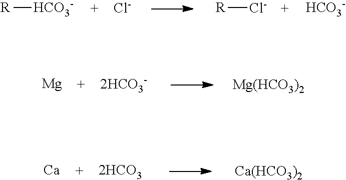

It has been found that a highly concentrated solution containing calcium hydrogen carbonate and/or magnesium hydrogen carbonate can be produced in this way. In particular, the concentration of the hydrogen carbonate solution can be close to the solubility limit.

The solution may already be provided by a single pass through the ion exchanger. The magnesium hydrogen carbonate or calcium hydrogen carbonate solution produced in this way is of high quality and has no impurities.

This highly concentrated solution can subsequently be used to enrich water, especially demineralized water, with magnesium hydrogen carbonate and/or calcium hydrogen carbonate. Due to the high concentration, only small amounts are required. In particular, one liter of the solution is sufficient for up to 200 L-1000 L of water, depending on the concentration.

For the solution containing magnesium salt and/or calcium salt, readily soluble magnesium chloride and/or calcium chloride or magnesium sulfate can be used.

According to one exemplary embodiment of the invention, a chloride-free and/or sodium-free water can be provided. Chloride-free and/or sodium-free is understood to mean a concentration of less than 1 mmol/l, preferably less than 0.1 mmol/l.

The adjustment of the desired concentration of the magnesium hydrogen carbonate and/or calcium hydrogen carbonate may in particular be achieved on the basis of the electrical conductivity of the water.

For example, a control valve may be controlled on the basis of conductivity.

More particularly, a conductivity target value of 50 to 2000 μS/cm for drinking water and/or preferably of 100 to 300 μpS/cm for coffee water can be set.

The concentrated solution may comprise 2-25 g/l, more particularly 5-20 g/l of magnesium hydrogen carbonate and/or calcium hydrogen carbonate.

In a refinement of the invention, the solution is fed into a pressure vessel, in particular an expansion vessel. The overpressure in the pressure vessel may in particular be between 1.5 and 10 bar.

In this way, a pressure vessel can be used to easily prevent carbon dioxide from outgassing, which would lead to the precipitation of magnesium carbonates or calcium carbonates that are formed.

If the pressure vessel comes in the form of an expansion vessel, the concentrate containing magnesium hydrogen carbonate or calcium hydrogen carbonate can be dosed into the water to be treated in a straightforward manner, in particular without using a pump.

The expansion vessel may in particular come in the form of a diaphragm expansion vessel. In such a vessel, an elastic diaphragm separates a gas volume from the concentrate. Via the gas volume, the pressure vessel can be pressurized throughout its entire use, in particular until the concentrate is used up. The diaphragm may come in the form of an intermediate wall, for example, or an inserted bladder.

In one embodiment of the invention, the pressure vessel is filled with carbon dioxide on the gas side. In particular, the gas volume of the pressure vessel may comprise carbon dioxide or consist of carbon dioxide.

In this way, a concentration gradient with respect to carbon dioxide is avoided, which could lead to the carbon dioxide escaping through the diaphragm, which in turn could lead to precipitation of the carbonates.

In a preferred embodiment of the invention, the anion exchanger is converted into the hydrogen carbonate form using sodium hydrogen carbonate and/or potassium hydrogen carbonate before the magnesium salt-containing or calcium salt-containing solution is passed therethrough. In particular, at least 30%, preferably 50% to 100%, most preferably 80% to 100% of the total capacity of the anion exchanger (according to DIN 54402:2009-04) can thus be provided in the hydrogen carbonate form.

Preferably, the anion exchanger is loaded with chloride ions beforehand. In particular chloride ions lead to a high selectivity, i.e. a rapid exchange into the bicarbonate form. As a result, the chloride ions are almost completely removed from the solution during the passing through.

The disclosure furthermore relates to a treated water that was produced using the process described above.

The water may in particular be free of chloride and/or of sodium.

Preferably, the water has a carbonate hardness of 5° dH to 20° dH for use as drinking water, and a carbonate hardness of 2° dH to 8° dH for use as coffee water.

The invention furthermore relates to a pressure vessel which in particular comes in the form of an expansion vessel.

This vessel comprises a solution containing calcium hydrogen carbonate and/or magnesium hydrogen carbonate. In particular, the pressure vessel comprises a solution that was prepared as described above. Furthermore, the pressure vessel may additionally contain a solution comprising magnesium chloride and/or magnesium sulfate, or magnesium chloride and/or calcium chloride, which is separately added in a dosed manner.

The total hardness of the solution may be greater than 200° dH, in particular between 400° dH and 800° dH.

The pressure in the pressure vessel is preferably 1.5-10 bar.

The invention furthermore relates to an installation system comprising the pressure vessel.

The installation system preferably also comprises a sensor for the electrical conductivity of the treated water and a valve that is controlled on the basis of the measured conductivity.

The valve is used to easily add, in a dosed manner, the concentrate containing calcium hydrogen carbonate and/or magnesium hydrogen carbonate, which allows to adjusted the mineral concentration, i.e. the hardness of the water, in a straightforward manner.

### DESCRIPTION OF AN EXEMPLARY EMBODIMENT

The preparation of the concentrate is accomplished in particular according to the process as described below.

In a first step, a weakly basic, medium basic or strongly basic ion exchanger, or a mixture of weakly and/or medium and/or strongly basic ion exchangers, is converted preferably from the chloride form into the hydrogen carbonate form. The hydrogen carbonate solution may consist of sodium hydrogen carbonate or potassium hydrogen carbonate, for example.

The concentration of the hydrogen carbonate solution may be between 5 and 10 g/l for sodium hydrogen carbonate. If potassium hydrogen carbonate is used, the solution may even be more concentrated, for example 15-25 g/l.

The loading of the ion exchanger is achieved as follows:

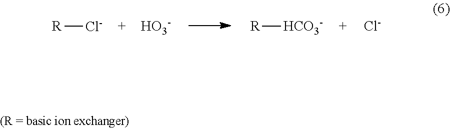

The output solution of the ion exchanger therefore contains predominantly NaCl or KCl.

In a second step, an aqueous solution of magnesium chloride or calcium chloride is passed through the anion exchanger loaded with hydrogen carbonate ions. Hereby, the hydrogen carbonate ion of the anion exchanger is exchanged for the chloride ion of the MgCl₂ or CaCl₂, respectively, and magnesium hydrogen carbonate or calcium hydrogen carbonate is formed.

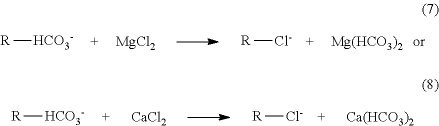

The concentration of calcium hydrogen carbonate and/or magnesium hydrogen carbonate flowing out of the ion exchanger can be adjusted via the concentration of the calcium chloride and/or magnesium chloride in the feed.

The concentration of the magnesium hydrogen carbonate produced in this way can be almost up to the solubility limit, usually up to 25 g/l Mg(HCO₃)₂.

Once the hydrogen carbonate has been produced, the anion exchanger will be back in the chloride form (R—CI⁻) and the process according to Eq. (6) and Eq. (7) or Eq. (8) can be repeated.

Instead of chloride salts, the whole process may also be carried out with nitrate salts.

If a highly concentrated solution of calcium hydrogen carbonate or magnesium hydrogen carbonate is produced, it can only be stored or transported for a longer period of time if no magnesium carbonate precipitates due to outgassing of CO₂ in the solution.

According to a further aspect of the invention, the solution is filled into a pressure vessel. This vessel preferably has an overpressure of 0.5 bar to 10 bar.

For treating or producing water, for example drinking water, coffee water, tea water, which preferably consists of a purely calcium- or magnesium-containing hydrogen carbonate solution, the concentrated solution is added in a dosed manner from a pressure vessel.

For this purpose, the water may be demineralized by a demineralization process, such as, e.g., reverse osmosis, a mixed bed exchanger, or diaphragm distillation.

The solution from the pressure vessel can then be added in a dosed manner into the salt-free or virtually salt-free outlet from the demineralization process via an adjustable valve, e.g. a ball valve, a needle valve, etc., without a dosing pump.

### BRIEF DESCRIPTION OF THE DRAWINGS

The subject-matter of the invention will now be explained in more detail with reference to the drawings of FIGS. 1 through 4.

FIG. 1 schematically illustrates the loading of the anion exchanger with hydrogen carbonate ions.

FIG. 2 shows the preparation of the concentrate.

FIG. 3 schematically illustrates the use of the concentrate for water treatment.

FIG. 4 is a flow chart according to one exemplary embodiment of the invention.

### DETAILED DESCRIPTION

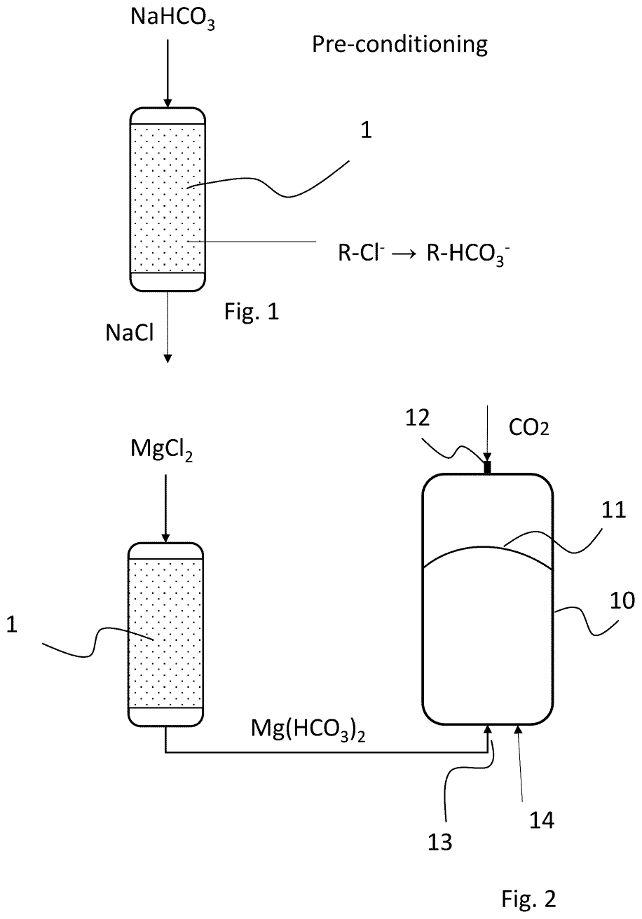

FIG. 1 shows a schematic view of a cartridge 1 containing an anion exchanger. In a first step, a solution containing sodium hydrogen carbonate is passed through the anion exchanger, which is in the form of chloride.

The ion exchanger will then be almost completely converted into the hydrogen carbonate form.

As schematically illustrated in FIG. 2, magnesium chloride is then passed through the cartridge 1 containing the anion exchange material.

This produces a concentrate containing magnesium hydrogen carbonate, which is fed into a pressure vessel 10 via the inlet 13.

The pressure vessel 10 is in the form of a diaphragm expansion vessel and comprises a diaphragm 11 which separates the gas volume from the liquid.

The gas inlet 12 may be used, for example, to add carbon dioxide in a dose manner. In this way, the risk of carbon dioxide outgassing is reduced.

Additionally, a solution containing magnesium chloride and/or magnesium sulfate or magnesium chloride and/or calcium chloride can be added to the pressure vessel in a dosed manner via inlet 14.

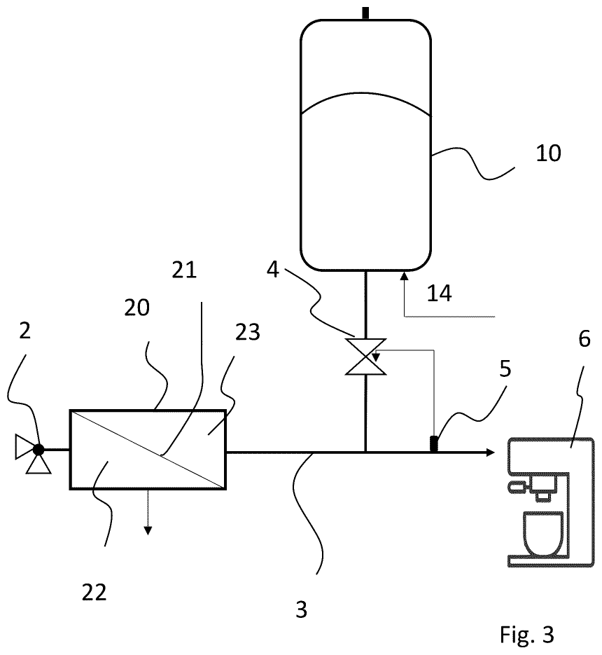

FIG. 3 shows an installation system.

This installation system comprises a water connection 2.

The incoming water from water connection 2 is demineralized.

In this exemplary embodiment, a reverse osmosis system 20 is provided for this purpose.

This system comprises a diaphragm 21 which separates the chamber of the reverse osmosis system 20 into a concentrate side 22 and a permeate side 23.

The salty concentrate is fed to the drain, while the permeate is virtually salt-free and is forwarded through line 3.

In order to enrich the permeate with a defined amount of magnesium hydrogen carbonate and/or calcium hydrogen carbonate, the pressure vessel 10 containing the concentrate is coupled to the line 3 via a valve 4.

Valve 4 is controlled on the basis of the electrical conductivity of the outlet water as measured by the conductivity sensor 5.

The water can then be used for a coffee machine 6, in the present exemplary embodiment a portafilter machine, to prepare coffee.

Since the composition of the outlet water is always the same due to the control system, it is ensured that the prepared coffee always tastes equally good. In particular, once the coffee machine settings (pressure, temperature, grinding level) have been optimized, they do not need to be changed any more.

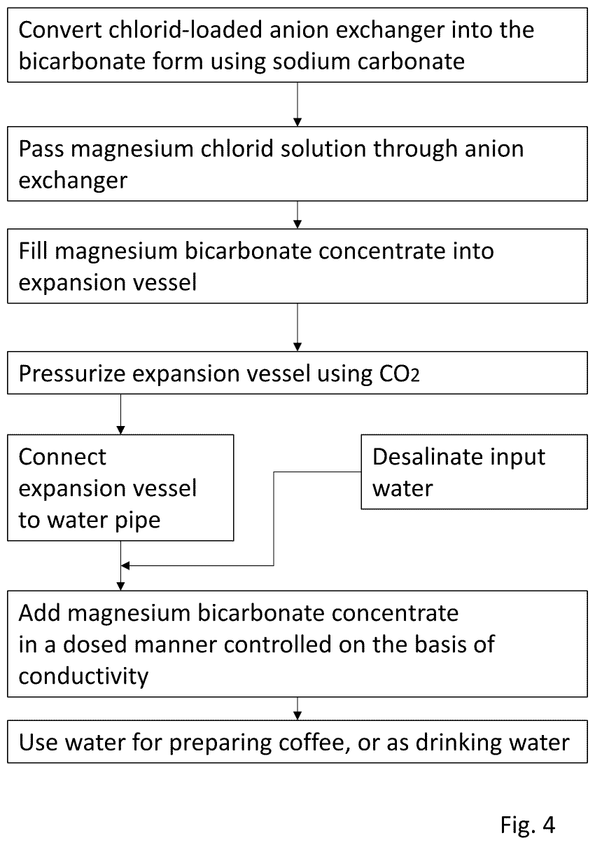

FIG. 4 is a flow chart of an exemplary embodiment of the process according to the invention.

First, an anion exchanger loaded with chloride is converted into the bicarbonate form by introducing a solution containing sodium bicarbonate.

Then, a magnesium chloride solution is passed through the anion exchanger.

The resulting magnesium bicarbonate concentrate is filled into an expansion vessel.

Via inlet 14, a solution containing magnesium chloride and/or magnesium sulfate or magnesium chloride and/or calcium chloride can be added in a dosed manner to the pressure vessel.

The expansion vessel is pressurized by introducing carbon dioxide.

The concentrate is subsequently used to treat demineralized water in a predefined manner.

The expansion vessel is connected to a water line through which the desalinated input water flows.

The concentrate is then added in a dosed manner controlled on the basis of conductivity.

Subsequently, the water is used to prepare coffee, for example.

The disclosure made it possible to provide a simple and effective process which allows to produce a highly concentrated solution containing calcium hydrogen carbonate and/or magnesium hydrogen carbonate.

### LIST OF REFERENCE NUMERALS

1 Cartridge with anion exchanger
2 Connection
3 Line
4 Valve
5 Conductivity sensor
6 Coffee machine
10 Pressure vessel
11 Diaphragm
12 Gas inlet
13 Inlet/Outlet
14 Inlet
20 Reverse osmosis system
21 Diaphragm
22 Concentrate side
23 Permeate side

1.-15. (canceled)

16. A process for producing magnesium hydrogen carbonate and/or calcium hydrogen carbonate, comprising:
providing an anion exchanger loaded with hydrogen carbonate ions; and
passing a solution containing magnesium salt and/or calcium salt through the anion exchanger.

17. The process as in claim 16, further comprising:
feeding the solution to a pressure vessel.

18. The process as in claim 16, further comprising:
feeding the solution to a diaphragm expansion vessel.

19. The process as in claim 16, wherein the solution containing magnesium salt and/or calcium salt contains magnesium sulfate and/or magnesium chloride and/or calcium chloride.

20. The process as in claim 16, further comprising:
adding a solution of the magnesium hydrogen carbonate and/or calcium hydrogen carbonate to a water to be treated in a dosed manner, and
using the water for preparing beverages.

21. The process as in claim 20,
wherein the adding in a dosed manner is controlled on a basis of an electrical conductivity of the water with a target electrical conductivity of the water being 50 to 2000 μS/cm for use as drinking water.

22. The process as in claim 20,
wherein the adding in a dosed manner is controlled on a basis of an electrical conductivity of the water with a target electrical conductivity of the water being 100 to 300 μS/cm for preparing coffee.

23. The process as in claim 16, further comprising
enriching the solution with 2 to 25 g/l of magnesium hydrogen carbonate and/or calcium hydrogen carbonate.

24. The process as in claim 16, further comprising
enriching the solution with 5 to 20 g/l of magnesium hydrogen carbonate and/or calcium hydrogen carbonate.

25. The process as in claim 17,
wherein the pressure vessel is filled with CO₂ on a gas side of the pressure vessel.

26. The process as in claim 16,
wherein the anion exchanger is converted into a hydrogen carbonate form with sodium hydrogen carbonate and/or potassium hydrogen carbonate before the solution containing magnesium salt and/or calcium salt is passed therethrough to at least 30% of its total capacity.

27. The process as in claim 26,
wherein the anion exchanger is converted from a chloride form into the hydrogen carbonate form.

28. A pressure vessel comprising a solution that contains calcium hydrogen carbonate and/or magnesium hydrogen carbonate.

29. An installation system, comprising the pressure vessel according to claim 28.

30. The installation system as in claim 29,
wherein the installation system comprises a conductivity sensor and a valve that is controlled based on a measured conductivity.
